(19) United States
(12) Patent Application Publication
(10) Pub. No.: US 2026/0321065 A1
(43) Pub. Date: Oct. 15, 2026

(54) SYSTEMS AND METHODS OF DETECTING HOOD LATCH STATE

(71) Applicant: Torc Robotics, Inc., Blacksburg, VA (US)

(72) Inventors: Adam Schneider, Christiansburg, VA (US); Gerardas Skeberdis, Hickory Hills, IL (US); Xholjon Dede, Esslingen am Neckar (DE); Sebastian Dingler, Stuttgart (DE); Paul Birth, Esslingen (DE)

(21) Appl. No.: 19/177,289

(22) Filed: Apr. 11, 2025

(51) Int. Cl. G07C 5/00; G06T 7/70; G07C 5/08

(52) U.S. Cl. CPC G07C 5/008; G06T 7/70; G07C 5/0825; G07C 5/0833; G06T 2207/30252

(57) ABSTRACT

A system for detecting a state of a hood latch of a hood of a vehicle is described. The system includes a sensor located on an exterior of the vehicle, one or more processors, and a memory coupled to the one or more processors storing machine executable instructions. The system is configured to receive, at the sensor, sensor data, the sensor data being associated with a period of time, calculate, using the sensor data, a displacement of the hood over the period of time, and determine, based on the displacement of the hood, a status of the hood latch.

### TECHNICAL FIELD

The field of the disclosure relates generally to perception systems of autonomous vehicle and, more specifically, utilizing the data collected by the perception systems of autonomous vehicles to detect a hood latch state.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, a system for detecting a state of a hood latch of a hood of a vehicle is disclosed. The system includes a sensor located on an exterior of the vehicle, one or more processors, and a memory coupled to the one or more processors storing machine executable instructions. The executable instructions, when executed by the one or more processors, configure the system to receive, at the sensor, sensor data, the sensor data being associated with a period of time, calculate, using the sensor data, a displacement of the hood over the period of time, and determine, based on the displacement of the hood, a status of the hood latch.

In another aspect, a method for detecting a state of a hood latch of a hood of a vehicle is disclosed. The method includes receiving, at a sensor of the vehicle, sensor data, the sensor data being associated with a period of time, calculating, by a processor and using the sensor data, a displacement of the hood over the period of time, and determine, based on the displacement of the hood, a status of the hood latch.

In yet another aspect, a non-transitory computer-readable storage medium, the non-transitory computer-readable storage medium is disclosed. The non-transitory computer-readable storage medium includes instructions that, when executed by a computer, configure the computer to receive, at a sensor in communication with the computer, sensor data, the sensor data being associated with a period of time, calculate, using the sensor data, a displacement of a hood of a vehicle over the period of time, and determine, based on the displacement of the hood, a status of a hood latch of the hood.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 depicts the autonomous truck in an exemplary environment;

FIG. 4 depicts a side view of the autonomous vehicle shown in FIG. 1, showing a field of view of the sensors;

FIG. 5A depicts a displacement of the hood in a latched state;

FIG. 5B depicts a displacement of the hood in an unlatched state;

FIG. 6 is a flow diagram of an example method of detecting a hood latch state; and

FIG. 7 is a block diagram of an example computing system.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

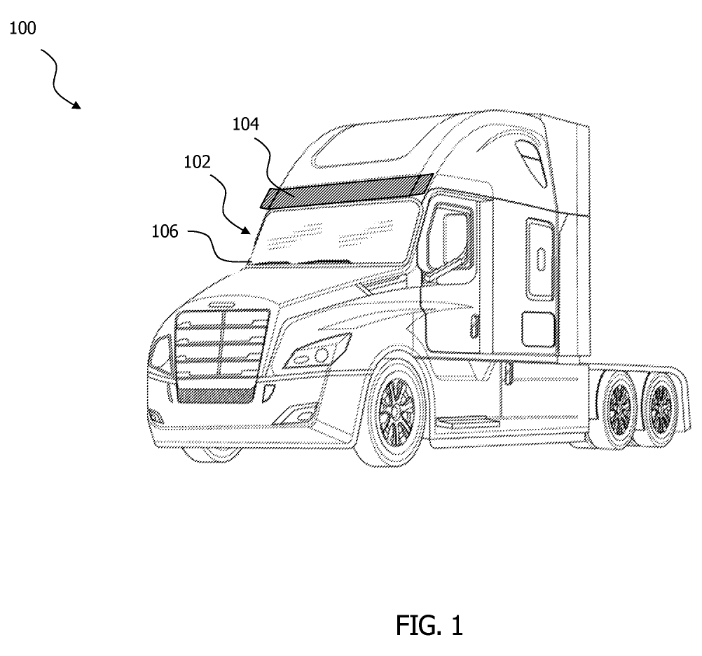

FIG. 1 illustrates a vehicle 100, such as a truck that may be conventionally connected to a single or tandem trailer to transport the trailer (not shown) to a desired location. The vehicle 100 includes a cabin 102 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of the cabin 102.

The vehicle includes a sensor bar 104. The sensor bar 104 may include one or more sensors on an exterior of the vehicle 100. In some instances, the sensor bar 104 is mounted directly above a windshield 106 of the vehicle 100. This allows for the sensors to gather data of the surroundings, while maintaining a clear view from within the cabin 102.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

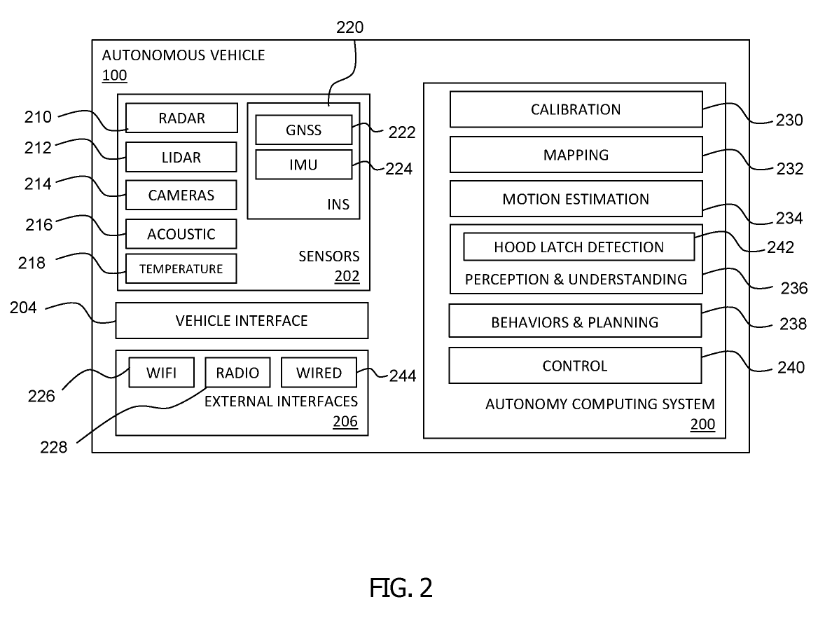

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may be located on the sensor bar 104, as shown in FIG. 1. In other embodiments, sensors may be mounted at any suitable location on the vehicle 100. Sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a hood latch detection module 242. The hood latch detection module 242, for example, may be embodied within another module, such as the perception and understanding module 236, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The hood latch detection module 242 may perform one or more tasks including, but not limited to analyzing data received by the sensors 202 to calculate a displacement or velocity of the hood over time. The results of the analysis can be used to determine a state of the hood latch. For example, if the latch is properly secured, the hood should not experience significant levels of displacement with respect to the sensors 202. However, if the hood latch is unsecured, a greater displacement will be experienced by the hood. The implementation of the hood latch detection module reduces the need for additional sensors to determine a state of the hood latch. This leads to overall safer operation of the vehicle.

In one instance, the hood latch detection module 242 may utilize collected by the LiDAR sensors 212. In other instances, the hood latch detection module 242 may utilize data collected by the cameras 214. This will be described in further detail below.

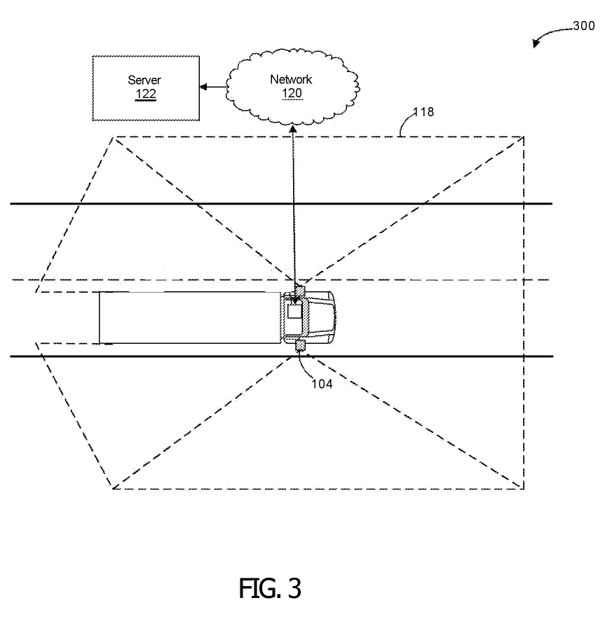

FIG. 3 illustrates an exemplary environment 300 of the vehicle 100. The vehicle 100 is capable of communicatively coupling to a remote server 122 via a network 120. The vehicle 100 may not necessarily connect with the network 120 or the server 122 while it is in operation (e.g., driving down the roadway). That is, the server 122 may be remote from the vehicle, and the vehicle 100 may deploy with all the necessary perception, localization, and vehicle control software and data necessary to complete the vehicle’s mission fully autonomously or semi-autonomously. FIG. 3 also depicts a field of view 118 which represents an area within which the sensors located on the sensor bar 104 collect data.

While this disclosure refers to a vehicle 100 as the autonomous vehicle, it is understood that the vehicle 100 could be any type of vehicle including a truck (e.g., a tractor trailer), an automobile, a mobile industrial machine, etc. While the disclosure will discuss a self-driving or driverless autonomous system, it is understood that the autonomous system could alternatively be semi-autonomous having varying degrees of autonomy or autonomous functionality. While the sensor bar 104 is depicted as being located at the front of the vehicle 100, the sensor bar 104 may be a part of a perception system with various sensors placed at different locations throughout the vehicle 100.

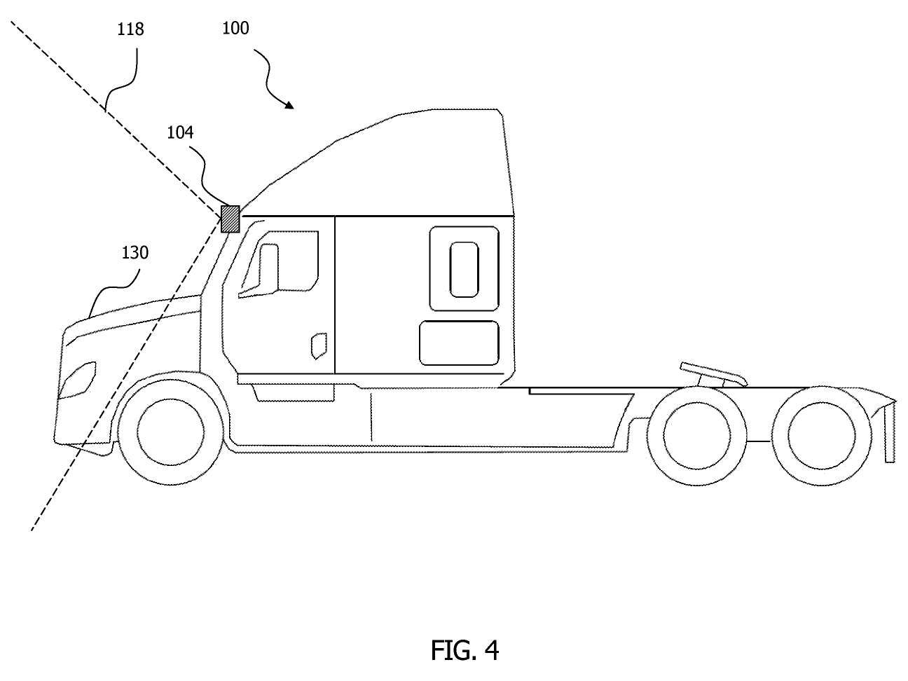

FIG. 4 depicts a side view of the vehicle 100, further depicting the field of view 118 of the sensors located in the sensor bar 104. As shown in FIG. 4, a hood 130 of the vehicle 100 is within the field of view 118.

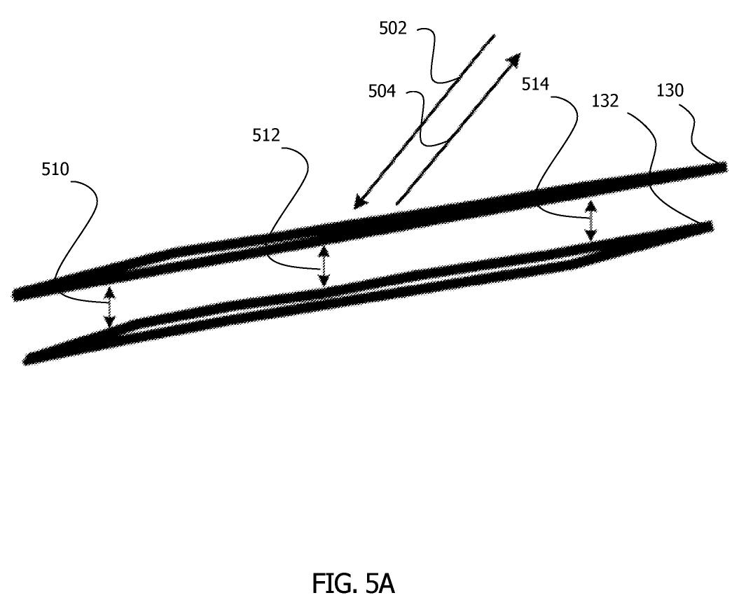

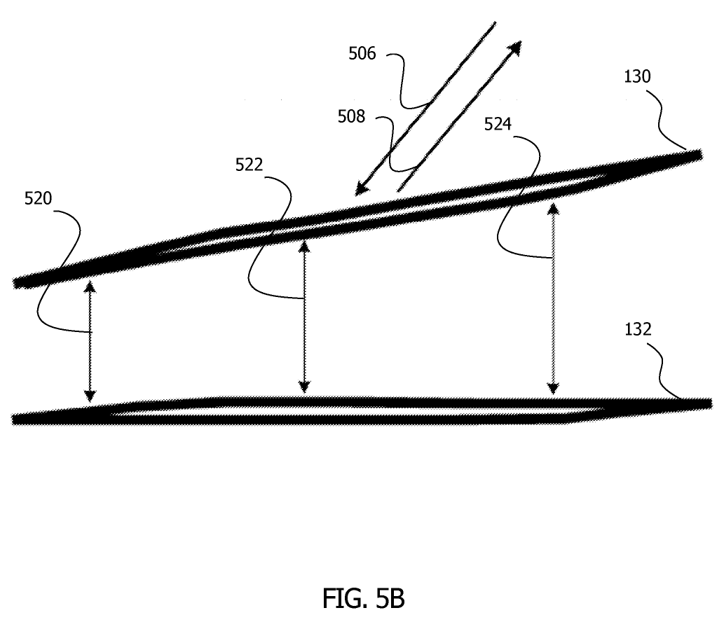

FIG. 5A depicts a displacement of the hood 130 in relation to a frame 132 in a latched state during a first time period. Arrow 502 represents a LiDAR pulse emitted from the LiDAR sensor 212, for example, located within the sensor bar 104. Arrow 504 represents a return of the pulse to the LiDAR sensor 212. A displacement is observed at a first point 510, a second point 512, and a third point 514 along the hood 130 to determine if any displacement is observed. In this instance, the displacement is small. Based on the data collected by the LiDAR sensor 212, the hood latch detection module 242 can determine that the hood latch is in a latched position.

It’s important to note that the expected displacement in the latched hood scenario is not exactly zero. Because the vehicle may be traveling down a roadway, some amount of jostling, or vibration, of the vehicle 100 is expected, and therefore, the hood 130 may experience a normal amount of displacement, even in the latched state. To account for this, the hood latch detection module 242 may require a calibration period in which the hood latch detection module 242 measures the displacement over a period of time wherein the status of the hood latch is known to be latched. After the calibration period, the hood latch detection module 242 will determine the latch is unsecured if a displacement greater than the calibration displacement, or in other words, if the displacement is greater than a threshold determined during calibration. In another example, the hood latch detection module 242 may determine the latch is unsecured if a significant change is observed in the displacement of the hood 130. For example, if the displacement exceeds a percentage greater of the previous measurement (e.g. 10-20%), the hood latch detection module 242 may determine that the status of the hood latch is unsecured.

FIG. 5B depicts a displacement of the hood 130 in relation to the frame 132 in an unlatched state during a second time period. Arrow 506 represents a LiDAR pulse emitted from the LiDAR sensor 212, for example, located within the sensor bar 104. Arrow 508 represents a return of the pulse to the LiDAR sensor 212. In this example, the displacement observed at the first point 520 during the second time period is greater than the displacement observed at the first point 510 during the first time period depicted in FIG. 5A. Further, the displacement observed at the second point 522 is greater than the displacement observed at the first point 510 and the displacement observed at the second point 512 during the first time period depicted in FIG. 5A. Further, the displacement observed at the third point 524 is greater than the displacement observed at the first point 520 and the second point 522 and the displacement observed at the third point 514 during the first time period depicted in FIG. 5A. In this instance, the displacement is 1) larger than the displacement observed in the first time period and 2) increasingly greater moving from the first point 520 to the second point 522 to the third point 524. Based on the observed differences in the displacement at the first point 520, the second point 522, and the third point 524, the hood latch detection module 242 determines that the hood latch is in an unlatched position.

In some instances, the hood latch detection module 242 may generate a warning based on the hood latch state. For example, the hood latch detection module, may send a command to an audible indicator of the vehicle to emit an audible alarm (beep, siren, tone) to alert a driver to the unlatched state of the hood latch. In some instances, the hood latch detection module 242 may send a command for a visual indicator of the unlatched state of the hood latch. For example, the visual indicator may appear on a console or dashboard or LCD screen of the vehicle 100. In some instances, the alert may be sent via the network 120 to the server 122 or another computing device.

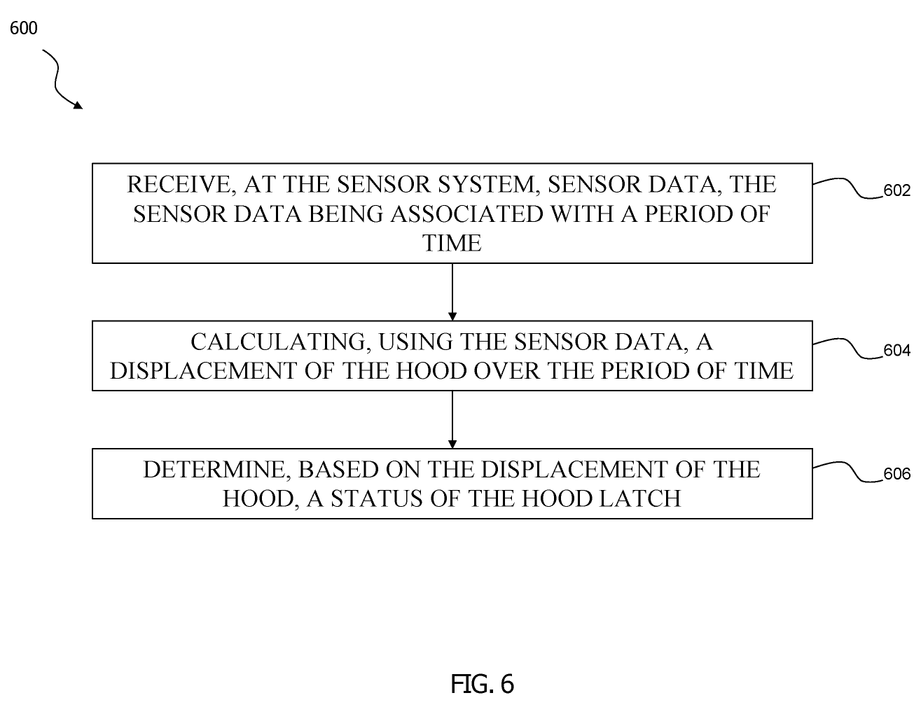

FIG. 6 is a flow diagram of an example method 600 of detecting a hood latch state. Method 600 may be embodied, for example, in vehicle 100 shown in FIGS. 1 and 2. More specifically, method 400 may be embodied in software configured for execution by a computing system, such as hood latch detection module 242 executing on the autonomy computing system 200 shown in FIG. 2. The module receives 602 sensor data, the sensor data being associated with a period of time. The module further calculates 604, using the sensor data, a displacement of the hood over a period of time. The module further determines 606, based on the displacement of the hood, a status of the hood latch.

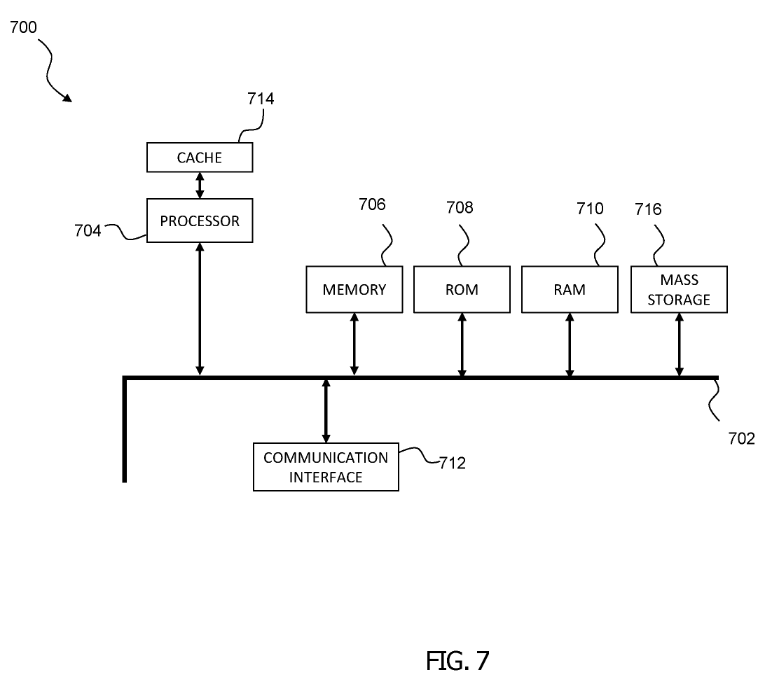

FIG. 7 illustrates an example computing system 700 that can implement various techniques, processes, functions, or methods described herein. The components of computing system 700 are shown in electrical communication with each other using a communication bus 702. The example computing system 700 includes a processor (CPU or processing unit) 704 coupled with communication bus 702 that couples various additional components to processor 704, including a memory 706, a read only memory (ROM) 708, and a random access memory (RAM) 310, and at least one communication interface 712. Communication interface 712 may include one or more additional components, such as integrated circuits, transceivers, transmitters, receivers, controllers, etc., for transmitting or receiving data over a channel. Such channels may include wired channels such as a serial channel, CAN bus, Ethernet or the like, or wireless channels employing protocols such as WiFi, Bluetooth, NFC, or other suitable wireless technologies.

In certain embodiments, as shown in FIG. 7, computing system 700 includes a cache 714 of high-speed memory connected directly with, in close proximity to, or integrated as part of processor 704. Computing system 700, in certain implementations, may copy data from memory 706 and/or a mass storage 716, also coupled with communication bus 702, to cache 714 for quick access by processor 704. In this way, cache 714 can improve performance of computing system 700 by reducing delays in processor 704 reading or writing data. These and other modules can store machine executable instructions for controlling, or configuring, processor 704 to perform various actions. Memory 706 can include multiple different types of memory with different performance characteristics. Processor 704 can include any general purpose processor, central processing unit (CPU), or graphics processing unit (GPU) in combination with a hardware or software provision configured to control processor 704. Such a software provision may be stored in memory 706, ROM 708, RAM 710, or mass storage 716. Processor 704 may, in certain embodiments, include a special-purpose processor where software instructions are incorporated into the processor design. Processor 704 may be a self-contained system, containing multiple cores or processors, a bus, memory controller, cache, etc. A multi-core processor may be symmetric or asymmetric.

Mass storage 716 is a non-volatile memory and can be one or more of a hard disk or other types of computer readable media that can store data that are accessible by a computer, such as a magnetic cassette, flash memory card, solid state memory device, digital versatile disk, cartridge, RAM, ROM, or hybrids thereof. Memory 706 or mass storage 716 can include machine executable instructions, software, code, firmware, etc., for controlling processor 704. In certain embodiments, processor 704 may be programmed, or configured, by encoding an operation or function using one or more machine executable instructions and providing the executable instructions in, for example, memory 706, ROM 708, RAM 710, or mass storage 716.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more machine executable instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for ‎purposes of description, a wide variety of alternate and/or equivalent embodiments or ‎implementations calculated to achieve the same purposes may be substituted for the ‎embodiments shown and described without departing from the scope of the present disclosure. ‎This application is intended to cover any adaptations or variations of the embodiments ‎discussed herein, including the implementation or utilization of components of the systems or steps independently and separately from other described components or steps. Therefore, it is manifestly intended that embodiments described herein be ‎limited only by the claims.

1. A system for detecting a state of a hood latch of a hood of a vehicle, the system comprising:
a sensor located on an exterior of the vehicle;
one or more processors; and
a memory coupled to the one or more processors storing machine executable instructions that, when executed by the one or more processors, configure the system to:
receive, at the sensor, first sensor data, the first sensor data being associated with a first period of time and including a first displacement between the hood and a frame of the vehicle at two or more points along a length of the hood;
receive, at the sensor, second sensor data, the second sensor data being associated with a second period of time and including a second displacement between the hood and the frame of the vehicle at the two or more points along the length of the hood;
determine that the hood latch is in an unlatched position if the second displacement is increasingly greater moving from a first point to a second point of the two or more points along the length of the length of the hood; and
based on determining that the hood latch is in the unlatched position, triggering a warning with an audible indicator or a visual indicator indicative of the unlatched position of the hood latch.

2. (canceled)

3. (canceled)

4. The system of claim 1 wherein if the warning is the visual indicator, the warning is displayed on a display within an interior of the vehicle.

5. The system of claim 1 wherein the warning is transmitted via a network to a computing device.

6. The system of claim 1, wherein the sensor is a Light Detection and Ranging (LiDAR) sensor.

7. The system of claim 1, wherein the sensor is a camera.

8. A method for detecting a state of a hood latch of a hood of a vehicle, the method comprising:
receiving, at a sensor of the vehicle, first sensor data, the first sensor data being associated with a period of time and including a first displacement between the hood and a frame of the vehicle at two or more points along a length of the hood;
receiving, at the sensor, second sensor data, the second sensor data being associated with a second period of time and including a second displacement between the hood and the frame of the vehicle at the two or more points along the length of the hood;
determining that the hood latch is in an unlatched position if the second displacement is increasingly greater moving from a first point to a second point of the two or more points along the length of the length of the hood; and
based on determining that the hood latch is in the unlatched position, triggering a warning with an audible indicator or a visual indicator indicative of the unlatched position of the hood latch.

9. (canceled)

10. (canceled)

11. The method of claim 8, wherein if the warning is the visual indicator,the warning is displayed on a display within an interior of the vehicle.

12. The method of claim 8, wherein the warning is transmitted via a network to a computing device.

13. The method of claim 8, wherein the sensor is a Light Detection and Ranging (LiDAR) sensor.

14. The method of claim 8, wherein the sensor is a camera.

15. A non-transitory computer-readable storage medium, the non- transitory computer-readable storage medium including instructions that, when executed by a computer, configure the computer to:
receive, at a sensor in communication with the computer, first sensor data, the first sensor data being associated with a first period of time and including a first displacement between the hood and a frame of the vehicle at two or more points along a length of the hood;
receive, at the sensor, second sensor data, the second sensor data being associated with a second period of time and including a second displacement between the hood and the frame of the vehicle at the two or more points along the length of the hood;
determine that the hood latch is in an unlatched position the second displacement is increasingly greater moving from a first point to a second point of the two or more points along the length of the length of the hood; and
based on determining that the hood latch is in the unlatched position, triggering a warning with an audible indicator or a visual indicator indicative of the unlatched position of the hood latch.

16. (canceled)

17. (canceled)

18. The non-transitory computer-readable storage medium of claim 15, wherein if the warning is the visual indicator, the warning is displayed on a display within an interior of the vehicle.

19. The non-transitory computer-readable storage medium of claim 15, wherein the warning is transmitted via a network to a computing device.

20. The non-transitory computer-readable storage medium of claim 15, wherein the sensor is a Light Detection and Ranging (LiDAR) sensor.
